(19) United States
(12) Patent Application Publication
(10) Pub. No.: US 2014/0037268 A1
(43) Pub. Date: Feb. 6, 2014

(54) MOVING IMAGE RECORDING APPARATUS CAPABLE OF RECORDING MOVING IMAGES TO RECORDING MEDIA, AND CONTROL METHOD AND STORAGE MEDIUM THEREFOR

(71) Applicant: CANON KABUSHIKI KAISHA, Tokyo (JP)

(72) Inventor: Ryota Shoji, Kawasaki-shi (JP)

(21) Appl. No.: 13/938,701

(22) Filed: Jul. 10, 2013

(30) Foreign Application Priority Data
Aug. 3, 2012 (KR) 2012-172966

(51) Int. Cl. H04N 5/85

(52) U.S. Cl. CPC H04N 5/85
USPC 386/248

(57) ABSTRACT

A moving image recording apparatus capable of, when recording of a video image to at least one recording medium is stopped in the process of simultaneous recording to a plurality of recording medium, recording a video image to other recording media and capable of preventing relevant video image IDs from being provided to the video images. A setting unit sets same identification information to moving images simultaneously recorded to recording media. When moving image recording to one of two recording media has been stopped but moving image recording to another recording medium is continued in the process of simultaneously recording moving images of same content to the two recording media, a control unit controls the setting unit such that identification information for which the recording has been stopped is differentiated from that for which the recording is continued.

### BACKGROUND OF THE INVENTION

1. Field of the Invention

The present invention relates to a moving image recording apparatus such as a video camera and a control method and a storage medium therefor, and more particularly, to a moving image recording apparatus capable of recording video images of the same content to a plurality of recording media and a control method and a storage medium therefor.

2. Description of the Related Art

Some of business-use cameras have a simultaneous recording function capable of simultaneously recording video images of the same content to two memory cards. By simultaneously recording video images of the same video image format, it is possible to eliminate a backup operation for creating a copy of video image and for recording it to another memory card after video image photographing. The term “same video image format” indicates that video images are the same as each other in all the settings at the time of video image photographing such as resolution, bit rate, frame rate, and compression format of video image.

By simultaneously recording video images of different video image formats, it is possible to eliminate an operation for creating a new video image file by converting video image format according to the purpose of use of video image after video image photographing.

With a camera having the simultaneous recording function, the same video image ID is provided to two video images simultaneously recorded in the same video image format. The term “video image ID” refers to information for identifying each individual video image. Video IDs are utilized for management of video images in the camera or on a personal computer (hereinafter, referred to as the PC). In a case, for example, that two video images are provided with the same video image ID, it is possible to determine based on the video image ID that these two video images are the same in video image format and in content. In another case where two video images are simultaneously recorded in different video image formats, these two video images are provided with video image IDs similar to each other. Based on the video image IDs, it is possible to determine that the two video images are different in video image format but the same in content. By providing relevant video image IDs to video images in this manner, video image data can be managed with ease after photographing.

It should be noted that video image IDs are generally added to video images at start of video image recording in order to prevent such a situation that the video image recording is finished without video image IDs being added to the video images due to occurrence of an accidental error in the camera during the video image recording.

Japanese Laid-open Patent Publication No. 2005-354623 discloses an image pickup apparatus capable of performing backup recording by using a plurality of recording media. In this apparatus, when the residual capacity of at least one of the recording media becomes less than a predetermined capacity, a subsequent photographing operation is prohibited. As a result, there is a fear that it becomes impossible to photograph a decisive scene.

Accordingly, it has been proposed to continue video image recording to one of two recording media even when the residual capacity of another recording medium becomes less than a predetermined capacity during execution of simultaneous recording to the two recording media. For example, it has been proposed to preferentially continue the recording to one of recording media immediately before the residual capacity of another recording medium decreases below a predetermined capacity.

However, in that case, a problem is posed that relevant video image IDs are added to two video images even though these video images are different in content and in recording time from each other.

### SUMMARY OF THE INVENTION

The present invention provides a moving image recording apparatus capable of solving at least one of the above-described problems, and provides a control method and a storage medium therefor.

According to one aspect of this invention, there is provided a moving image recording apparatus comprising a recording unit configured to record moving images of same content to a plurality of recording media based on an input moving image, a setting unit configured, in a case where moving images are recorded to the plurality of recording media by the recording unit, to set identification information to the moving images recorded to the recording media, and a control unit configured, in a case where in process of recording moving images of same content to the plurality of recording media by the recording unit, moving image recording to at least one of the plurality of recording media has been stopped but moving image recording to other recording media is continued, to control the setting unit such that identification information for which the recording has been stopped is differentiated from identification information for which the recording is continued.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1A is a block diagram schematically showing an image pickup apparatus having a moving image recording apparatus according to one embodiment of this invention;

FIG. 1B is a view showing data structure of a video image photographed by the image pickup apparatus;

FIG. 2 is a flowchart showing procedures of an image pickup process performed by the image pickup apparatus;

FIG. 3A is a flowchart showing procedures of a video image recording process executed by the image pickup apparatus to record a video image to one of recording media in a case where a setting for simultaneous recording has not been set;

FIG. 3B is a flowchart showing procedures of a video image recording process executed by the image pickup apparatus to record a video image to another recording medium in a case where a setting for simultaneous recording has been set;

FIG. 4 is a view showing how video image IDs are added by the image pickup apparatus;

FIG. 5 is a view showing how video image IDs are added in a case where simultaneous recording to three recording media is carried out;

FIG. 6A is a view showing a selection screen for selectively continuing simultaneous recording in the image pickup apparatus; and

FIG. 6B is a view showing how remaining capacities of recording media are displayed on the screen.

### DESCRIPTION OF THE EMBODIMENTS

Various exemplary embodiments, features, and aspects of the invention will be described in detail below with reference to the drawings.

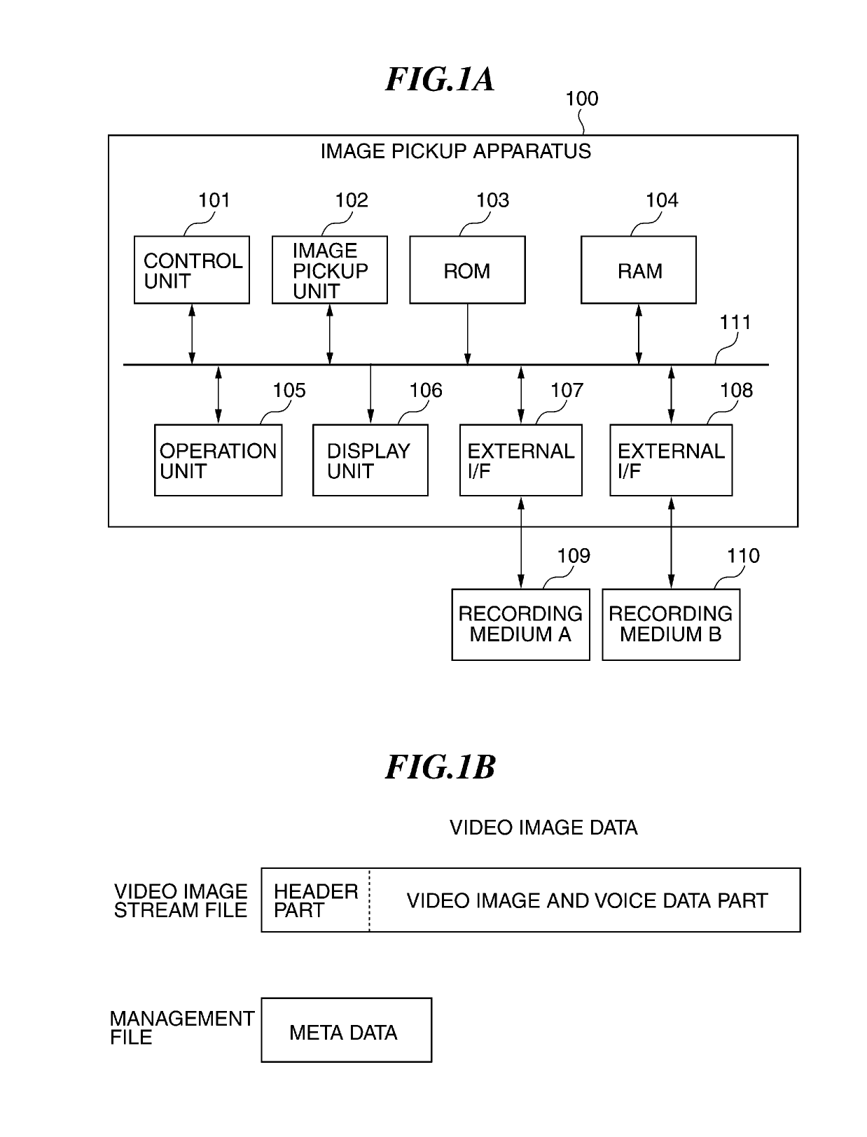

FIG. 1A schematically shows in block diagram the construction of an image pickup apparatus having a moving image recording apparatus according to one embodiment of this invention. In FIG. 1A, reference numeral 101 denotes a control unit that controls the entire image pickup apparatus 100. The control unit 101 controls respective units (described below) of the image pickup apparatus 100 according to user's settings and operations.

An image pickup unit 102 has optical lenses and an image pickup device such as a CCD or a CMOS that converts light (video image) introduced thereto via the optical lenses into an electrical signal. Under the control of the control unit 101, the image pickup unit 102 performs, for example, adjustment of sensitivity of the image pickup device (gain control), data reading from the image pickup device according to shutter time, and exposure control while changing aperture or shutter speed.

A ROM 103 is a memory that stores programs for controlling the image pickup apparatus 100 and data for use by the programs. When power supply to the image pickup apparatus 100 is turned on, the control unit 101 reads a program from the ROM 103 and starts controlling the image pickup apparatus 100.

A RAM 104 is a rewritable memory used as a work area by programs that control the image pickup apparatus 100. The RAM 104 is also used as a buffer that temporarily stores image data output from the image pickup unit 102.

An operation unit 105 is used to input a user's instruction to the image pickup apparatus 100. The operation unit 105 includes buttons such as a photographing button and a menu button, a dial, and a touch panel. The user can operate the operation unit 105 to set whether photographing with simultaneous recording should be made.

Reference numeral 106 denotes a display unit for displaying a video image according to an instruction given by the control unit 101. The display unit 106 includes a thin display device such as a liquid crystal device (LCD) and a display drive unit that controls the display device.

On the display unit 106, a menu for making various settings of the image pickup apparatus 100 is displayed, and a photographed image is displayed to enable the user to confirm the image. The display unit 106 is used as a finder that displays video image data output from the image pickup unit 102 for determining a composition of an object, and also used as a viewer that displays a video image stored in recording media 109, 110 (hereinafter, sometimes referred to as recording media A, B). It should be noted that an arbitrary graphic image can be displayed on the display unit 106 in a manner superimposed on a photographed image.

The recording media 109, 110 store photographed images and other data, and are connected via external I/Fs 107, 108 to the image pickup apparatus 100. Each of the recording media 109, 110 can be configured by a detachable memory such as an SD memory card, a compact flash (registered trademark) card, or a memory stick, and can also be configured by an external drive such as a hard disk drive or a solid state drive.

The control unit 101 through the external I/F 108 are connected to an internal bus 111 serving as a transfer path for control signals and data signals.

In the image pickup apparatus 100 constructed as described above, a photographed video image is encoded into MPEG-2 format by the control unit 101 and stored as a video image stream file.

At the same time of creation of the video image stream file, a management file is created as shown in FIG. 1B. In the management file, meta data (such as photographer, photographed content, recording time, frame rate, resolution, etc. of the video image) are recorded. A set of files of the video image stream file and the management file are recorded for one video image data. It should be noted that in the image pickup apparatus 100, an operation of recording to each recording medium is controlled to be stopped when the residual capacity of the recording medium becomes less than a predetermined capacity in the process of video image recording.

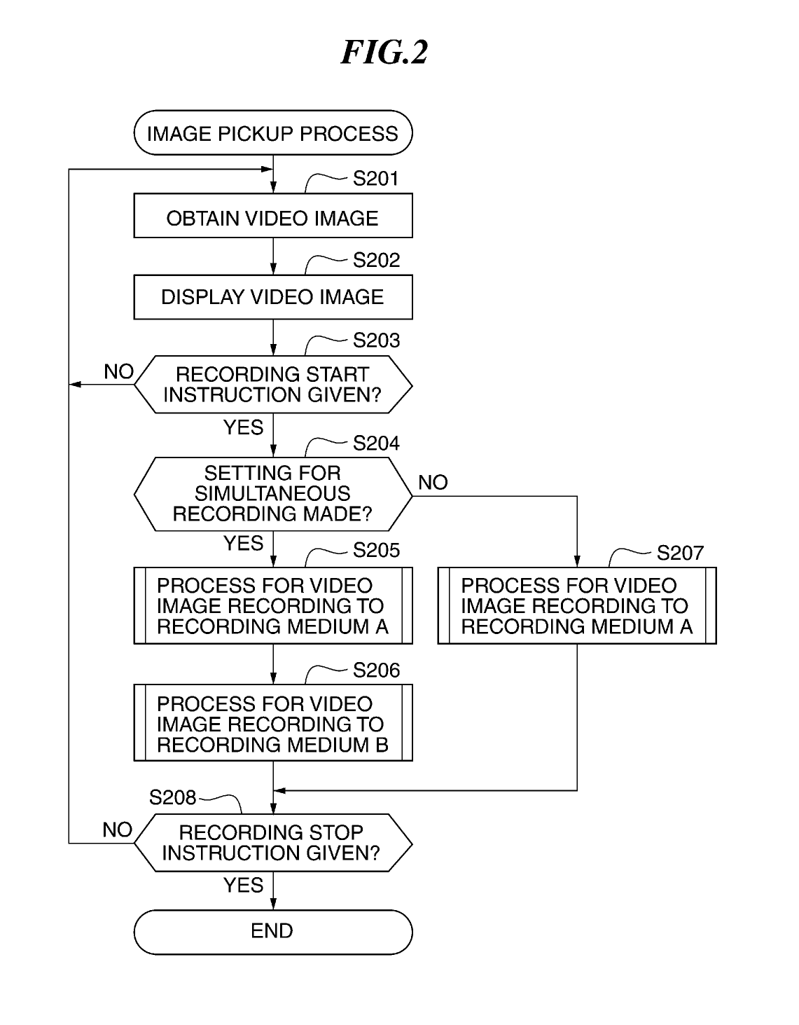

Next, a description will be given of an image pickup process performed by the image pickup apparatus 100 with reference to FIG. 2. In the following description of the image pickup process, it is assumed that settings of the image pickup apparatus 100 are made in advance by the user so as to perform photographing with simultaneous recording in the same video image format. It should be noted that the term “simultaneous recording” not only refers to a case where the same data is recorded to a plurality of recording media at strictly the same time, but also refers to a case where the same data is sequentially recorded to the plurality of recording media in a timesharing manner.

When the user starts a photographing operation, the image pickup apparatus 100 starts an image pickup process. In the image pickup unit 102 of the image pickup apparatus 100, a video image input via the optical lenses is converted into electronic data by the image pickup device, and the electronic data is output as image data to the control unit 101 (step S201).

Next, the control unit 101 causes the display unit 106 to display the image data obtained in step S201 as video image used for composition decision or used for preview (step S202). At that time, the image data output from the image pickup unit 102 in step S201 is adjusted to be adapted to the resolution of the display unit 106 and then displayed on the display unit 106.

Next, the control unit 101 determines whether or not a recording start instruction is given by the user (step S203). If determined that a recording start instruction is given (if YES to step S203), the control unit 101 proceeds to step S204. If determined that a recording start instruction is not given (if NO to step S203), the control unit 101 returns to step S201 where video image used for composition decision or used for preview is updated.

In step S204, the control unit 101 determines whether or not the settings of the image pickup apparatus 100 have been made such as to perform photographing with simultaneous recording. If determined that such settings have been made (if YES to step S204), the control unit 101 proceeds to step S205 where the control unit 101 records image data into the recording medium A via the external I/F 107.

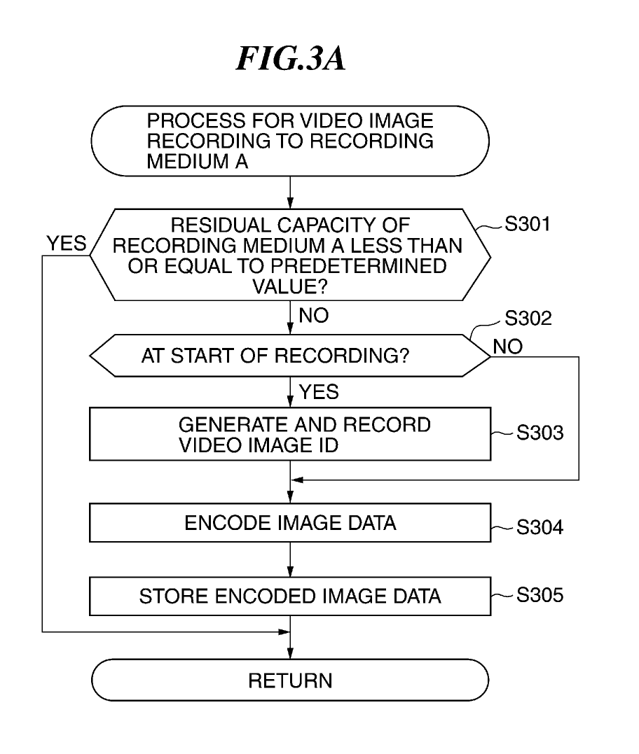

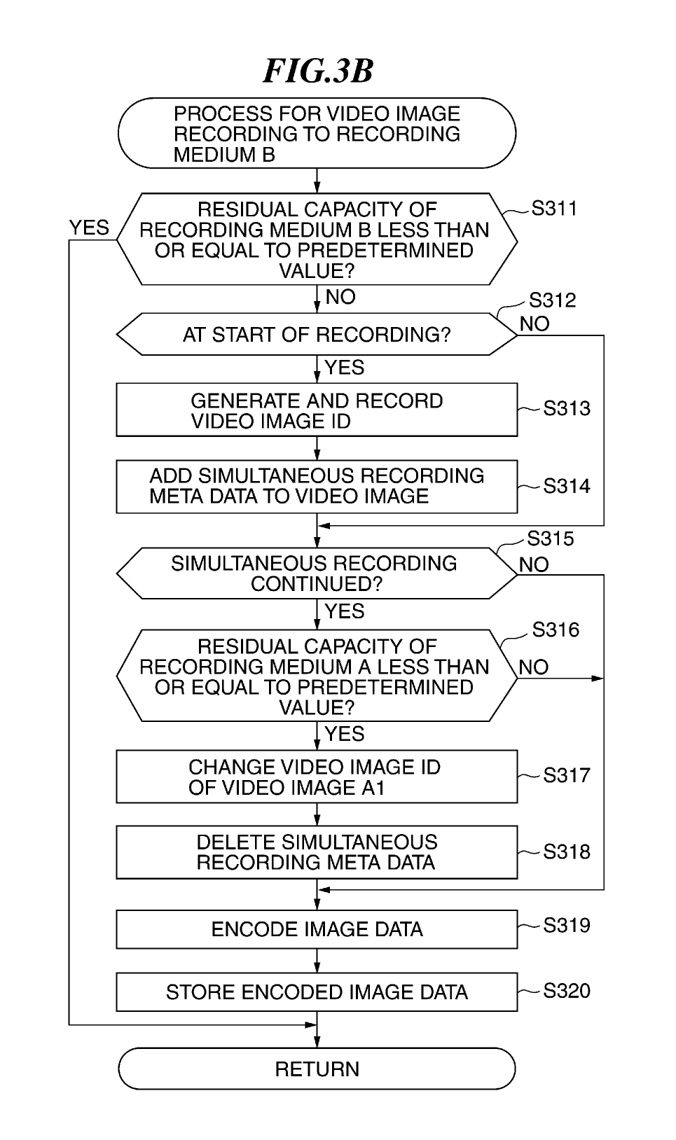

Next, the control unit 101 records into the recording medium B via the external I/F 108 the same image data as that recorded into the recording medium A in step S205 (step S206). The details of an operation in step S206 for image data recording for a case where a setting for simultaneous recording has been made will be described later referring to FIG. 3A.

If determined that the setting for photographing with simultaneous recording has not been set for the image pickup apparatus 100 (if NO to step S204), the control unit 101 proceeds to step S207 where it records image data into the recording medium A via the external I/F 107. The details of an operation in step S207 for image data recording for a case where the setting for simultaneous recording has not been made will be described later referring to FIG. 3B.

Next, the control unit 101 determines whether or not a recording stop instruction is given by the user (step S208), and stops the simultaneous recording, if determined that a recording stop instruction is given (if YES to step S208). If determined that a recording stop instruction is not given (if NO to step S208), the control unit 101 returns to step S201 to repeat the above-described routine.

Next, referring to FIG. 3A, a description will be given in detail of the process for recording video image into the recording medium A performed instep S207 when the setting for simultaneous recording has not been set.

At start of the process for recording video image into the recording medium A, the control unit 101 determines whether or not a residual capacity of the recording medium A is less than or equal to a predetermined value (step S301). If determined that the residual capacity is less than or equal to the predetermined value (if YES to step S301), the control unit 101 completes the recording process. If determined that the residual capacity is neither less than nor equal to the predetermined value (if NO to step S301), the control unit 101 proceeds to step S302.

In step S302, the control unit 101 determines whether or not a current recording operation is one to be performed at start of the recording. If determined that the current recording operation is one to be performed at start of the recording (if YES to step S302), the control unit 101 proceeds to step S303. If determined that the current recording operation is not one to be performed at start of the recording (if NO to step S302), the control unit 101 proceeds to step S305.

In step S303, the control unit 101 generates a video image ID for video image data generated by the current recording operation, and records it in a header part of a video image stream file. By adding the video image ID to the video image data in this manner at the start of video image recording, it is possible to prevent video image with no video image ID from being generated when the video image recording is interrupted by an accidental error occurring subsequently during the video image recording.

Next, the control unit 101 encodes image data output from the image pickup unit in a predetermined compression method such as MPEG2 (step S304).

Next, the control unit 101 stores the encoded image data into video image and voice data part of the video image stream file according to a predetermined storing rule (step S305).

Next, referring to FIG. 3B, a description will be given in detail of the process for recording video image into the recording medium B performed in step S206 under the setting for simultaneous recording. It should be noted that under the setting of simultaneous recording, an operation for recording into the recording medium A is performed in step S205, as with the case shown in FIG. 3A. In the following, video image data recorded into the recording media A and B will be referred to as the video images A1 and B1, respectively.

In the video image recording process, the control unit 101 first determines whether or not the residual capacity of the recording medium B (i.e., the recording medium for which the recording operation is being performed) is equal to or less than a predetermined value (step S311). If determined that the residual capacity is equal to or less than the predetermined value (if YES to step S311), the control unit 101 completes the recording operation. If determined that the residual capacity is neither equal to nor less than the predetermined value (if NO to step S311), the control unit 101 proceeds to step S312.

In step S312, the control unit 101 determines whether or not a current recording operation is one to be performed at start of the recording. If determined that the current recording operation is one to be performed at start of the recording (if YES to step S312), the control unit 101 proceeds to step S313. If determined that the current recording operation is not one to be performed at start of the recording (if NO to step S312), the control unit 101 proceeds to step S315.

In step S313, the control unit 101 generates a video image ID (0x01 in this example), and records the video image ID into a header part of a video image stream file for the video image B1. In this embodiment, since the simultaneous recording is performed in the same video image format, the same video image ID is added also to the video image A1.

Next, the control unit 101 records, into the header part of the video image stream file for the video image B1, meta data (hereinafter, referred to as the simultaneous recording meta data) indicating that the currently recorded video image is recorded under the setting for simultaneous recording (step S314).

Next, the control unit 101 determines whether or not the simultaneous recording for the recording media A and B is currently continued (step S315). To this end, the control unit 101 determines whether or not the video image IDs of the video images A1 and B1 are equal to each other, or determines whether or not the simultaneous recording meta data has been added to both the video images A1 and B1. If determined that the simultaneous recording is not continued (if NO to step S315), the control unit 101 proceeds to step S319.

If determined that the simultaneous recording is continued (if YES to step S315), the control unit 101 determines whether or not the residual capacity of the recording medium A (another recording medium) is less than or equal to a predetermined value (step S316). If determined that the residual capacity is neither less than nor equal to the predetermined value (if NO to step S316), the control unit 101 proceeds to step S319.

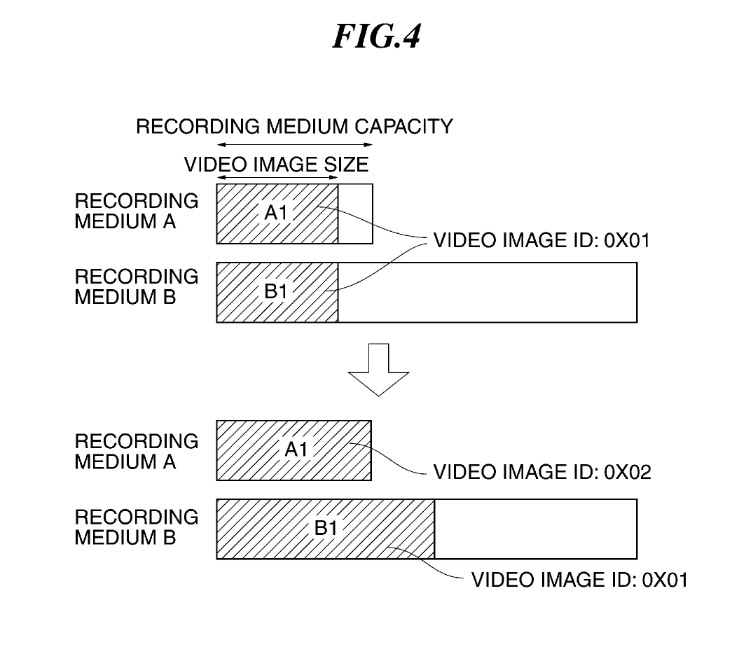

If determined that the residual capacity is less than or equal to the predetermined value (if YES to step S316), the control unit 101 proceeds to step S317 where the control unit 101 changes the video image ID of the video image A1 to a video image ID (0x02 in this example) different from the currently added video image ID (0x01), as shown in FIG. 4. In stead of changing the video image ID of the video image A1, the video image ID of the video image B1 can be changed.

Next, the control unit 101 deletes the simultaneous recording meta data recorded in the header parts of the video image stream files for the video images A1, B1 or in the management files (step S318), and then proceeds to step S319.

In step S319, the control unit 101 encodes image data output from the image pickup unit in a predetermined compression method such as MPEG2. Next, the control unit 101 stores the image data encoded in step S319 into video image and voice data part of video image stream file according to a predetermined storing rule (step S320).

With the above-described video image recording process, it is possible to prevent the same video image ID from being added to both the video images A1, B1 in a case where the video image B1 is continued to be recorded even after the recording of the video image A1 is stopped during the simultaneous recording.

It should be noted that in this embodiment, a case has been described where recording is stopped because of the residual capacity of one of the recording media becoming less than or equal to the predetermined value during the simultaneous recording. However, this invention is also applicable to a case where recording is stopped because of occurrence of an error during the video image recording.

Although video image IDs are represented by 0x01 and 0x02 in this embodiment for simplicity of description, globally unique identifiers (hereinafter, referred to as the GUIDs) or codes generated based on the GUIDs can be used as video image IDs, whereby it is ensured that video images to which different video image IDs are added are different in content from one another.

In this embodiment, a case has been described where a video image ID or simultaneous recording meta data is recorded in a header part of a video image stream file and a video image ID is added to video image at start of video image recording. However, the video image ID or the like can be recorded into a management file, and the video image ID can be generated and recorded during the video image recording or at completion thereof.

In the construction shown in block diagram of FIG. 1A, the image pickup apparatus 100 having two external I/Fs has been described. However, the present invention is also applicable to an apparatus having three or more external I/Fs to each of which a recording medium can be connected and configured to perform simultaneous recording into recording media currently connected to the external I/Fs. For example, video image IDs can be changed when recording to the recording medium A is stopped during the simultaneous recording to three recording media A, B and C respectively connected to three external I/Fs.

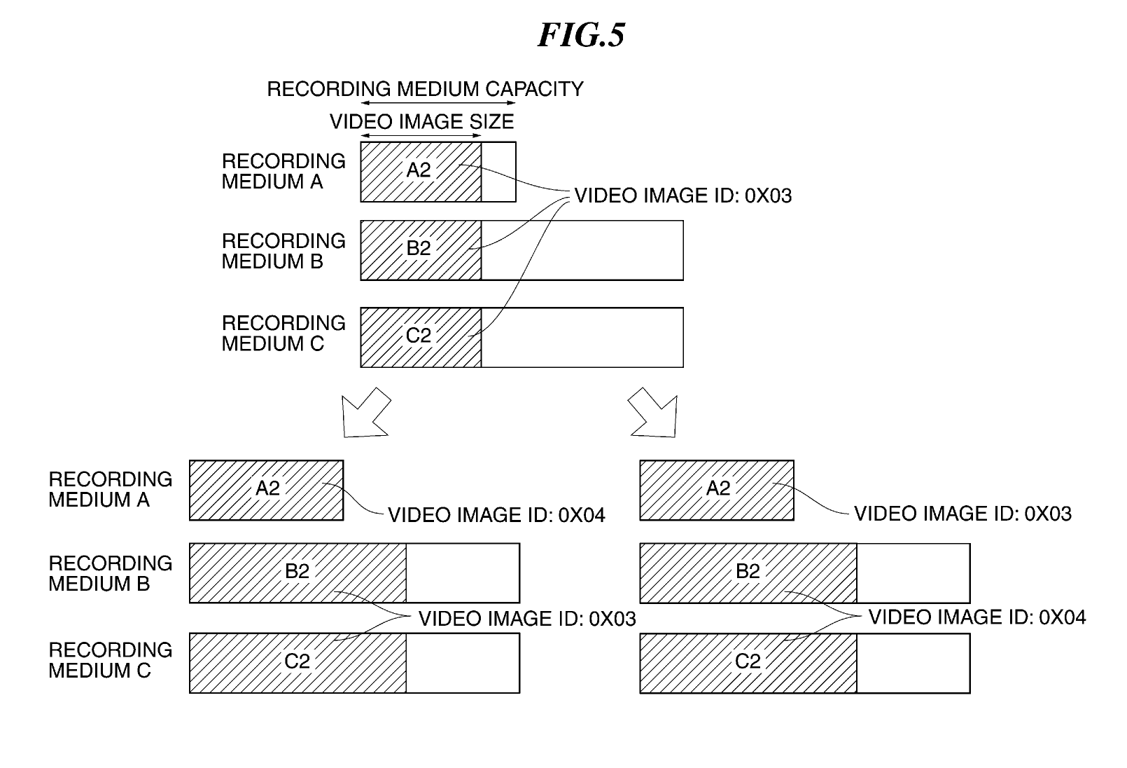

With reference to FIG. 5, a description will be given of how video image IDs are changed in that case. Video images simultaneously recorded to the recording media A, B, and C will be referred to as the video images A2, B2, and C2, respectively, and it is assumed that the same video image ID of e.g. 0x03 is added to the video images A2, B2, and C2.

In the video image ID changing method shown in FIG. 5, simultaneous recording of the video images B2, C2 is continued after stoppage of recording of the video image A2. Thus, only the video image ID of the video image A2 is changed to e.g. 0x04 or the video image IDs of the video images B2, C2 are changed to e.g. 0x04. Subsequently, only simultaneous recording meta data for the video image A2 is deleted. By doing this, it is possible to prevent the same video image ID from being added to the video image A2 and to the video images B2, C2 which are different in content from the video image A2.

As another modification, different video image IDs can be recorded to moving images at start of simultaneous recording, and upon completion of recording of the moving images which are the same in content, the different video image IDs first recorded to the moving images can be changed to the same video image ID.

In the embodiment, there has been described a case where simultaneous recording of video images of the same video image format is performed, however, this invention is also applicable to a case where simultaneous recording of video images of different video image formats is performed.

For example, it is possible to apply this invention to a case where during the simultaneous recording of an HD video image with resolution of 1920×1080 to the recording medium A and an SD video image with resolution of 720×480 to the recording medium B, the recording to the recording medium A is stopped.

It is assumed here that the video image IDs applied to the HD video image and to the SD video image are 0x01H and 0x01S, respectively. These video image IDs of 0x01H and 0x01S are not the same as each other but have a common part of 0x01, thereby making it possible to determine that the two video images were photographed in different video image formats. As with the case of step S317 in FIG. 3B, the video image ID of the HD video image of the recording medium A can be changed to 0x02H to indicate that the two video images are not the same in content.

For management of video images photographed and captured to a PC, information representing that recording was finished in the process of simultaneous recording can be added to the video image A1 of the embodiment, and information representing that simultaneous recording (backup recording) was finished in the process of video image recording (such as a time code at completion of simultaneous recording) can be added to the video image B1. These information can be utilized for search query in the management of video images by the PC or the like.

The video image B1 of the embodiment includes all the contents of the video image A1. Accordingly, when photographed video images are captured by e.g. a PC, an operation for capturing the video image A1 from the recording medium A can be omitted by previously capturing the video image B1 from the recording medium B. To this end, the image pickup apparatus of the embodiment can be configured to provide e.g. a message stating that “Please use media in the slot B to capture a currently photographed video image in your PC” e.g. at a timing of completion of recording of the video image B1, as a guidance to the user to indicate a method for capturing the video image with reduced operation load.

With the image pickup apparatus according to the embodiment, it is possible to achieve a user's demand that recording to the recording medium B should be stopped when recording to the recording medium A is stopped during simultaneous recording. To this end, the image pickup apparatus can be configured to enable the user to set before the start of photographing whether or not recording to the recording medium B should be stopped when recording to the recording medium A is stopped. It should be noted that a menu screen for making such setting can be displayed on the display unit 106 by operating the operation unit 105 by the user.

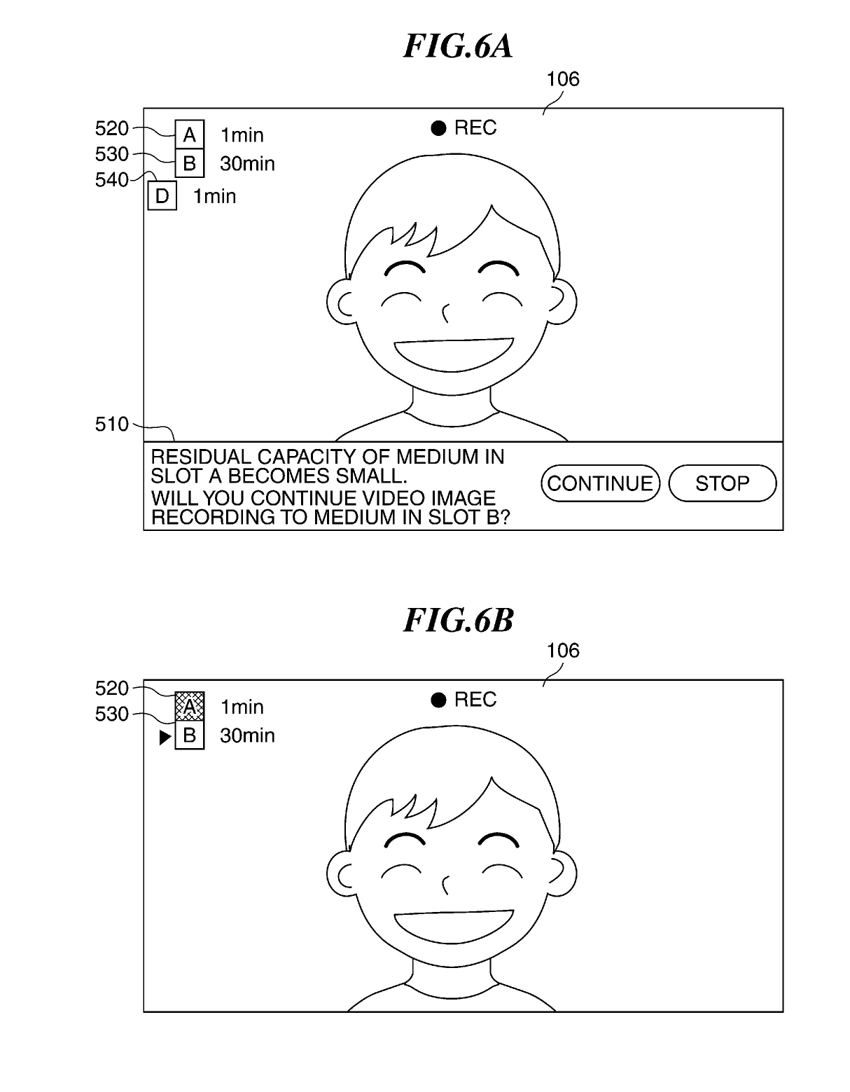

In the image pickup apparatus of the embodiment, a dialog 510 can be displayed on the screen of the display unit 106, as shown in FIG. 6A, when the residual capacity of the recording medium A becomes less than a predetermined value, to thereby enable the user to select whether or not video image recording should be continued. It should be noted that reference numerals 520, 530, and 540 in FIG. 6A denote fields in which the residual capacity of the recording medium A, the residual capacity of the recording medium B, and a possible simultaneous recording time are respectively indicated. When a “continue” button is pressed on the dialog 510, the screen display on the display unit 106 is changed as shown for example in FIG. 6B, thereby making it possible to notify the user that simultaneous recording to the recording media A and B is currently interrupted and video image recording to only the recording medium B is being continued.

The image pickup apparatus of the embodiment can be configured to generate moving images of the same content from image information obtained from a single image pickup device. It should be noted that the moving images of the same content may be moving images that are different from one another in at least one of the resolution, bit rate, brightness, chroma, contrast, compressibility, and compression method of moving image, and pieces of identification information similar to one another can be set to these moving images by a setting unit.

The image pickup apparatus of the embodiment can be configured such that information indicating that moving image recording has been finished in the process of simultaneous recording is added to e.g. at least one of a stream file and a management file of a moving image whose recording has been finished. Alternatively, information indicating that simultaneous recording has been interrupted during moving image recording can be added to e.g. at least one of a stream file and a management file of a moving image whose recording is continued.

The image pickup apparatus of the embodiment can be configured to have a display unit for displaying information that represents possible recording capacities in recording media. The information representing possible recording capacities can be changed and displayed on the display unit when video image recording to at least one of the recording media is finished, but video image recording to another recording medium is continued.

As described above, with the image pickup apparatus according to the embodiment, video images whose contents or recording times are different from one another can be prevented from being provided with relevant video image IDs.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-172966, filed Aug. 3, 2012, which is hereby incorporated by reference herein in its entirety.

1. A moving image recording apparatus, comprising:
a recording unit configured to record moving images of same content to a plurality of recording media based on an input moving image;
a setting unit configured, in a case where moving images are recorded to the plurality of recording media by said recording unit, to set identification information to the moving images recorded to the recording media; and
a control unit configured, in a case where in process of recording moving images of same content to the plurality of recording media by said recording unit, moving image recording to at least one of the plurality of recording media has been stopped but moving image recording to other recording media is continued, to control said setting unit such that identification information for which the recording has been stopped is differentiated from identification information for which the recording is continued.

2. The moving image recording apparatus according to claim 1, wherein in response to said recording unit starting to record moving images to the plurality of recording media, said setting unit provides the moving images with same identification information, and
in response to moving image recording to at least one of the plurality of recording media being stopped in the process of recording moving images of same content to the plurality of recording media by said recording unit, said setting unit changes the identification information provided to any of the moving images.

3. The moving image recording apparatus according to claim 1, wherein recording formats of moving images can be selected individually of one another, and
said setting unit provides same identification information to moving images of same recording format.

4. The moving image recording apparatus according to claim 1, wherein said setting unit sets, to moving images, attribute information representing that recording has been made in a mode for recording moving images of same content.

5. The moving image recording apparatus according to claim 1, wherein the moving images of same content are generated from image information obtained from a single image pickup device.

6. The moving image recording apparatus according to claim 1, wherein the moving images of same content are video image data of same video image format.

7. The moving image recording apparatus according to claim 1, wherein the moving images of same content are different from one another in at least one of resolution, bit rate, brightness, chroma, contrast, compressibility, and compression method of moving image, and
pieces of identification information representing that moving images are similar to one another are set to the plurality of moving images by said setting unit.

8. The moving image recording apparatus according to claim 1, wherein in a case where recording to at least one recording medium has been stopped in the process of recording moving images of same content to the plurality of recording media by said recording unit, information representing that moving image recording has been finished in the process of the moving image recording is set by said setting unit to the moving image whose recording has been stopped or to the moving image whose recording is continued.

9. The moving image recording apparatus according to claim 1, further including:
a display unit configured to display remaining times for which moving images of same content can be recorded to the plurality of recording media.

10. A control method for a moving image recording apparatus, comprising:
a recording step of recording moving images of same content to a plurality of recording media by using a recording unit based on an input moving image;
a setting step of, in a case where moving images are recorded to the plurality of recording media by the recording unit, setting identification information to the moving images recorded to the recording media; and
a control step of, in a case where in process of recording moving images of same content to the plurality of recording media by the recording unit, moving image recording to at least one of the plurality of recording media has been stopped but moving image recording to other recording media is continued, controlling the setting unit such that identification information for which the recording has been stopped is differentiated from identification information for which the recording is continued.

11. A non-transitory computer-readable storage medium storing a program for causing a computer to execute control method for a moving image recording apparatus comprising:
a recording step of recording moving images of same content to a plurality of recording media by using a recording unit based on an input moving image;
a setting step of, in a case where moving images are recorded to the plurality of recording media by the recording unit, setting identification information to the moving images recorded to the recording media; and
a control step of, in a case where in process of recording moving images of same content to the plurality of recording media by the recording unit, moving image recording to at least one of the plurality of recording media has been stopped but moving image recording to other recording media is continued, controlling the setting unit such that identification information for which the recording has been stopped is differentiated from identification information for which the recording is continued.
